(19) United States
(12) Patent Application Publication
(10) Pub. No.: US 2026/0081463 A1
(43) Pub. Date: Mar. 19, 2026

(54) ELECTRIC METER AND METHOD FOR COLD LOAD PICK-UP MANAGEMENT

(71) Applicant: Landis+Gyr Technology, Inc., Alpharetta, GA (US)

(72) Inventor: David SCHAMBER, Alpharetta, GA (US)

(21) Appl. No.: 19/107,227

(22) PCT Filed: Oct. 5, 2023
(86) PCT No.: PCT/US2023/076153

§ 371 Date: Feb. 27, 2025

Related U.S. Application Data
(60) Provisional application No. 63/414,101, filed on Oct. 7, 2022.

(51) Int. Cl. H02J 13/12

(52) U.S. Cl. CPC H02J 13/12; H02J 3/001; H02J 13/1331; H02J 13/34

(57) ABSTRACT

Systems and methods for management of the connection of cold loads to an electrical distribution network are disclosed. One disclosed system for managing connection of cold loads to an electrical distribution network includes an electric meter configured to detect a restoration of power following an outage, and in response to detecting the restoration of power following the outage, restarting operation and entering a service limiter mode. The electric meter remains in the service limiter mode for a predetermined period of time. While in service limiter mode, the electric meter accumulates power and compares the accumulated power to a threshold value to determine whether to control a service switch to connect or disconnect one or more loads from an electrical distribution network. After another predetermined period of time, the electric meter may reconnect the one or more loads to the electrical distribution network and return to normal operations.

### TECHNICAL FIELD

The present disclosure generally relates to management of the connection of loads to an electrical distribution network after an outage.

### BACKGROUND

Electrical distribution networks are comprised of numerous interconnected devices over a large geographic area. The interconnected devices are generally used to monitor and distribute power to user premises, and may include power assets, such as transformers, protective devices such as switches, line sections, and electric meters associated with user premises.

Electrical distribution networks are generally optimized to handle nominal or typical steady-loads. Because of this, electrical distribution networks may be vulnerable to sudden atypical increases in demand. Sudden increases in demand may stress or damage devices on the electrical distribution network, which may result in an outage event. In the event that an outage event is widespread and occurs over a prolonged period of time, restarting the electrical distribution network runs the risk of stressing devices on the electrical distribution network due to cold load pick-up. Cold load pick-up occurs when loads that have lost power, e.g. cold loads, are reconnected to the electrical distribution network. The connection of cold loads to the electrical distribution network causes an inrush of current. The inrush current may damage power assets and other devices of the electrical distribution network. Sudden demand from large loads such as electric heat, electric water heaters, etc. may overburden the electrical distribution network and result in further outages. Thus, there is a need for a management system to control the connection of loads to an electrical distribution network.

### SUMMARY

The present disclosure includes an electric meter that may be connected to an electrical distribution network. The electric meter includes metrology for measuring power from an electrical distribution network, a processing unit for determining whether an outage has occurred and whether power has been restored, and an optional communications module for communicating with a central system. In some implementations, the electric meter may also include one or more service switches, a controller, and memory which may store parameters of operation of the electric meter.

In one example of a method for operating the electric meter, in response to detecting a restoration of power following an outage, the electric meter restarts operation and enters a service limiter mode. The electric meter remains in the service limiter mode for a predetermined period of time. While in service limiter mode, the electric meter monitors power from an electrical distribution network to a premises through the electric meter, and accumulates the power during a service limiter demand period. The accumulated power for the service limiter demand period is compared to a service limiter threshold and when the accumulated power of the service limiter demand period is within the service limiter threshold, the electric meter controls a service switch so the premises remain connected to the electrical distribution network. While in the service limiter mode, the electric meter may also determine an amount of time that has elapsed since entering the service limiter mode and when the amount of time has elapsed since entering the service limiter mode meets or exceeds the predetermined amount of time, the electric meter exits the service limiter mode and enters a normal operating mode.

In other examples, when the accumulated power for the service limiter demand period exceeds the service limiter threshold, the electric meter controls the service switch to disconnect the premises from the electrical distribution network. The electric meter then may wait for a second predetermined period of time before controlling the service switch to connect the premises to the electrical distribution network.

### BRIEF DESCRIPTION OF THE FIGURES

These and other features, aspects, and advantages of the present disclosure are better understood when the following Detailed Description is read with reference to the accompanying drawings, where:

FIG. 1 is a flowchart illustrating an exemplary method of operation of an electric meter in service limiter mode.

FIG. 2 is a flowchart illustrating an exemplary method of operation of an electric meter transitioning between a service limiter mode and normal operating mode.

FIG. 3 is a block diagram illustrating components of an exemplary electric meter.

FIG. 4 is a block diagram illustrating a portion of an exemplary electrical distribution network.

FIG. 5 is a block diagram illustrating an exemplary communications network for an electrical distribution network.

### DETAILED DESCRIPTION

Aspects of the present disclosure relate to a system for managing the connection of a premises to an electrical distribution network after experiencing an outage event. A premises may include multiple loads. When premises are disconnected from the electrical distribution network, the loads associated with the premises may become cold loads. Cold loads are loads that have lost power for a period of time long enough that the load reaches a de-energized or low power state. The reconnection of a premises with cold loads to power sources or the electrical distribution network may cause the premises to experience cold load pick-up issues. The power demands of cold loads are generally higher when initially connected to the electrical distribution network. In instances of outage events, where various premises may have lost power for a period of time long enough to have cold loads, the connection of the premises to the electrical distribution network may cause a higher amount of demand than the electrical distribution network is typically configured to provide, which may cause stress or damage to the electrical distribution network resulting in further outages.

Cold load pick-up management is a utility provider's ability to manage the sudden demand placed on the electrical distribution network due to premises with cold loads receiving power. Electric meters may be used to manage cold load pick-up at a premises by limiting service to the premises so that demand does not exceed the capabilities of the electrical distribution network. The electric meters may assist with cold load pick-up management by limiting demand once power is restored. In some examples, the electric meter may manage demand by controlling an open/closed state of a service switch so that the electric meter may connect and disconnect a premises associated with the electric meter from the electrical distribution network when the electrical distribution network restores power after an outage.

When the electric meter detects power restoration after an outage, the electric meter determines whether the length of the outage was likely sufficient to cause the premises to have cold loads. Where the outage is momentary, the premises may not have cold loads, and the electric meter may resume normal metering operations, however when the outage is long enough to likely cause the premises to have cold loads, the electric meter may enter service limiter mode. Service limiter mode is a mode of operation of the electric meter wherein the electric meter manages power to the premises.

The electric meter may rely on parameters of the electric meter such as timer values and threshold values to determine whether to connect or disconnect a premises from the electrical distribution network. For example, upon enabling service limiter mode, the electric meter may begin a cold load pick-up timer. While the cold load pick-up timer is running, the electric meter may accumulate demand at the premises and compare the demand to a threshold value, such as a service limiter threshold. The service limiter threshold may be a preset threshold value representing an amount of power allotted by the utility provider for use at a premises while the electric meter is in service limiter mode.

When the demand at the premises is less than the threshold value, the service switch may remain closed. If the demand at the premises exceeds the service limiter threshold, the electric meter may open the service switch to disconnect the premises from the electrical distribution network for a predetermined amount of time. After the predetermined amount of time elapses, the electric meter closes the service switch to reconnect the premises to the electrical distribution network. Once the cold load pick-up delay timer has expired, the electric meter may transition from service limiter mode to a normal operating mode wherein the electric meter resumes normal metering operation.

The timer and the threshold values may vary between electric meters. Parameters of the electric meter may be based on the location of the electric meter in the electrical distribution network, the type of premises or loads at the premises, the account options associated with the premises, etc. The values may be preset at the electric meter by a utility provider or central system. Further description of the parameters and operations of the electric meter are discussed below.

### Exemplary Methods of Operation

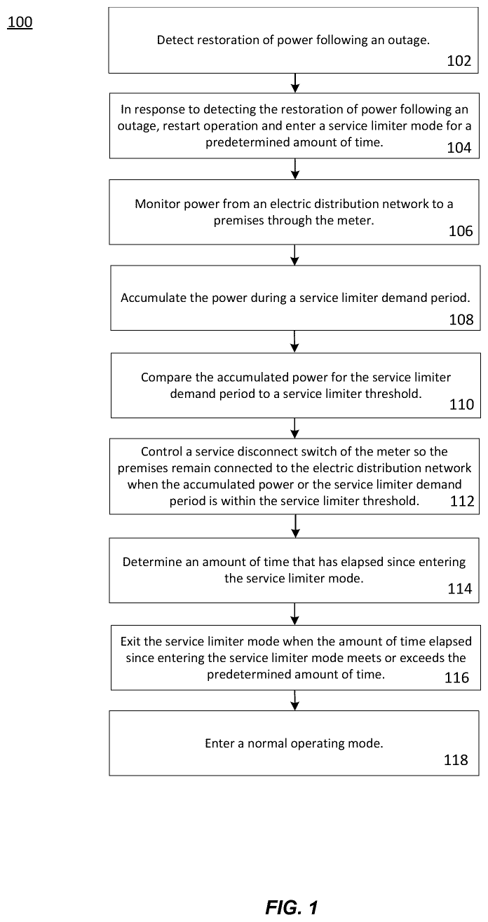

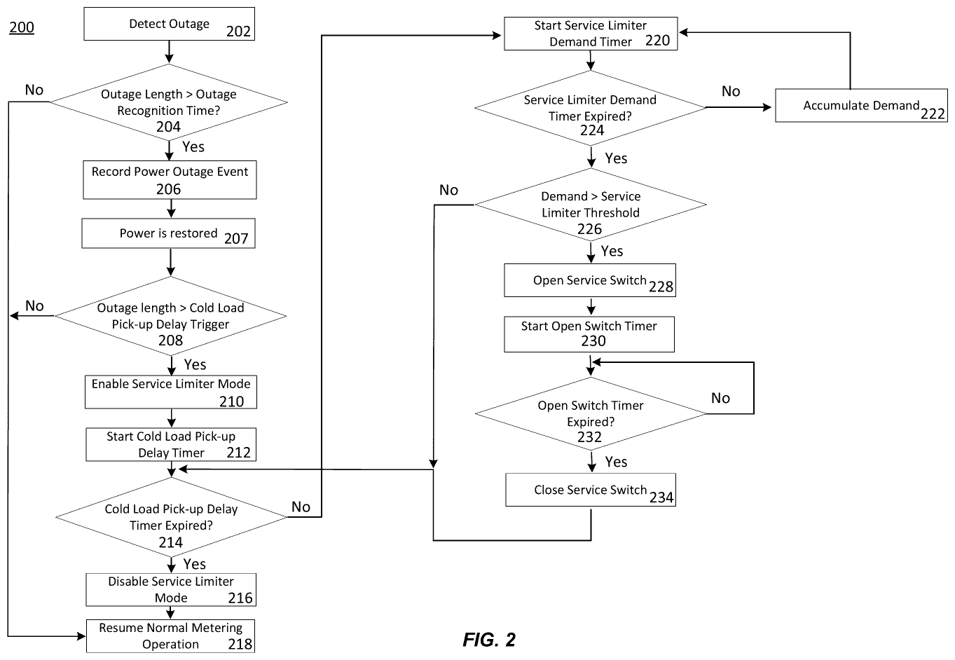

FIG. 1 and FIG. 2 are flowcharts showing illustrative methods for operation of the electric meter. In some examples, some of the steps in the flowcharts of FIGS. 1 and 2 are implemented in program code executed by a processor of the electric meter. In some examples the steps shown in FIGS. 1 and 2 are performed in a different order or one or more steps may be skipped. Alternatively, in some examples, additional steps not shown in FIGS. 1 and 2 may be performed.

FIGS. 1 and 2 illustrate that the electric meter monitors power consumed from the electrical distribution network and determines to connect or disconnect the premises from the electrical distribution network based on monitored power information.

### Exemplary Method of Operation of an Electric Meter in Service Limiter Mode

FIG. 1 is a flowchart illustrating an exemplary method 100 of operation of an electric meter controlling connection of a load to an electrical distribution network. The method starts at Step 102, where the electric meter detects restoration of power following an outage. In response to detecting restoration of power following an outage, the electric meter restarts operation and enters a service limiter mode for a predetermined period of time (Step 104).

The service limiter mode is a mode of operation wherein the electric meter may allow an allotted amount of power to one or more loads at the premises. When the prescribed amount of power is exceeded, the electric meter may disconnect the premises from the electrical distribution network.

The electric meter monitors power from an electrical distribution network to a premises through the electric meter (Step 106) and accumulates the power during a service limiter demand period (Step 108). The service limiter demand period is a predetermined period of time wherein the electric meter determines whether the demand of the loads exceeds a service limiter threshold. The service limiter threshold is a preset value set by a utility provider at the electric meter that represents an allotted amount of power of the electrical distribution network that may be used at a premises.

The electric meter compares the accumulated power for the service limiter demand period to a service limiter threshold in Step 110. Based on the comparison of the accumulated power to the service limiter threshold, the electric meter controls a service switch of the electric meter so that the premises remains connected to the electrical distribution network when the accumulated power or the service limiter demand period is within the service limiter threshold (Step 112).

The electric meter determines the amount of time that has elapsed since entering the service limiter mode (Step 114) and exits the service limiter mode when the amount of time elapsed meets or exceeds the predetermined amount of time (Step 116).

After exiting the service limiter mode, the electric meter may enter a normal operating mode (Step 118). The electric meter does not control the service switch based on the service limiter threshold while in the normal operating mode.

### Exemplary Method of Operation of an Electric Meter Upon Restoration of Power

FIG. 2 is a flowchart illustrating an exemplary method 200 of operation of an electric meter connecting and disconnecting a premises from an electrical distribution network.

The method starts at Step 202 when the electric meter detects an outage event. The electric meter may be configured to measure power associated with the electrical distribution network, and when the electric meter detects an absence of power or power falling below a predetermined power threshold for an amount of time greater than an outage recognition time, the electric meter may determine the electrical distribution network is experiencing an outage event (Step 204). The outage recognition time is a predetermined period of time that may be set by a utility provider.

When the electric meter determines that the outage event did not persist for longer than the outage recognition time, the method continues to Step 218, where the electric meter operates in normal operating mode. While in normal operating mode, the electric meter performs normal metering operation.

When the electric meter determines that the outage event has occurred and persisted for longer than the outage recognition time, the method progresses from Step 204 to Step 206, where the electric meter records the power outage event. The electric meter may record the power outage event in memory at the electric meter, or may transmit a record of the power outage event to an edge computing device or central system.

When power is restored (Step 207), the electric meter determines whether the outage event persisted for amount of time greater than a cold load pickup delay trigger (Step 208). The cold load pickup delay trigger is a predetermined period of time set at the meter to determine whether the outage event persisted for a long enough period of time for the premises to have cold loads.

When the outage event does not persist for a period of time greater than the cold load pickup delay trigger, the electric meter resumes normal metering operation (Step 218). When the outage event does persist for a period of time greater than the cold load pickup delay trigger, the electric meter enters service limiter mode (Step 210). Service limiter mode is a mode of operation of the electric meter wherein the electric meter manages power demands on the electrical distribution network by the premises. The electric meter may manage power demands by connecting or disconnecting the premises.

When entering service limiter mode, the electric meter starts a cold load pick-up delay timer (Step 212). The cold load pick-up delay timer is a timer that specifies how long the electric meter will remain in service limiter mode.

The electric meter determines whether the cold load pick-up delay timer has expired (Step 214). When the electric meter determines that the cold load pick-up delay timer has expired, the electric meter disables service limiter mode (Step 216) and transitions to normal operating mode wherein the electric meter resumes normal metering operation (Step 218).

When the electric meter determines that the cold load pick-up timer has not expired, the electric meter starts a service limiter demand timer (Step 220). While the service limiter demand timer is running, the electric meter may accumulate demand of the loads associated with the electric meter (Step 222). When the service limiter demand timer expires, the electric meter determines whether the demand for power by the loads during the service limiter demand period exceeded a service limiter threshold (Step 226). The service limiter threshold is a preset value set at the electric meter that represents an allotted amount of power that may be used by the premises during a service limiter demand period. When demand of the loads does not exceed the service limiter threshold, the electric meter progresses to Step 214.

When demand of the loads exceeds the service limiter threshold, the electric meter opens a service switch (Step 228). The service switch is a switch configured to connect or disconnect the premises from the electrical distribution network. The service switch may be located at the electric meter. Upon opening the service switch (Step 228), the electric meter starts an open switch timer (Step 230). The open switch timer tracks the amount of time that the service switch has been opened (Step 232). When the open switch timer expires, the electric meter closes the service switch (Step 234), and returns to Step 214.

In some examples, the electric meter may receive a restart command while in service limiter mode. Upon receiving the restart command, the electric meter resumes normal metering operation. If the service switch was open when the restart command is received, the electric meter closes the service switch. The restart command may be a command received from an input at the meter, such as by pushing a button, pulling a lever, or adjusting a switch. The restart command may also be a command sent by an edge computing device or a central system.

### Exemplary Meter

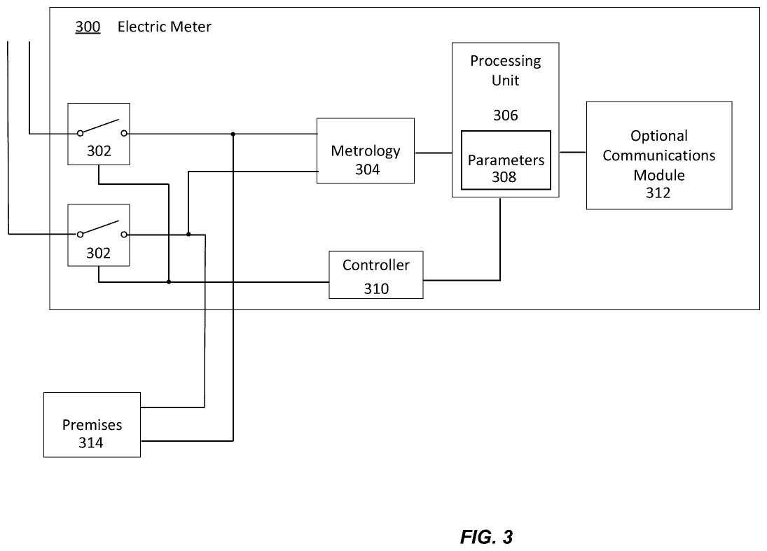

The foregoing describes that the electric meter performs a variety of functions, including metrology functions, processing functions, and communications functions. In some implementations, these functions may be performed by different components. FIG. 3 depicts an electric meter 300 that includes two service switches 302, metrology components 304, processing unit 306, parameters 308, controller 310, and an optional communications module 312. The electric meter 300 is connected to a premises 314, which may include one or more loads (not shown). The electric meter may be configured to connect to single-phase power or multi-phase power. In FIG. 3, the electric meter is a two-phase meter with a service switch for each phase.

The one or more service switches 302 are configured to connect and disconnect the premises from an electrical distribution network (not shown). The service switches 302 may also be connected to controller 310 and metrology components 304. In some examples, the service switches 302 are controlled through controller 310, which may send control signals configured to adjust an open and closed state of the service switches 302.

In other examples, the electric meter may control one or more load control switches instead of the service switches during service limiter mode. A load switch may be located outside of the electric meter and may be associated with one or more loads.

The metrology components 304 may measure voltage, current, power, or other characteristics of the electrical distribution network. The processing unit 306 may process the measurements by the metrology components 304 to determine whether an outage event has occurred. The processing unit 306, e.g. a processor or other processing device, also may include preset parameters 308. The parameters 308 may be stored in memory located at the processing unit 306, or stored in memory at other locations at the electric meter 300. In some examples, the parameters 308 are set and/or modified by a central system, such as a headend system. The parameters 308 may also be preset at manufacture or installation or set or modified during a configuration of the electric meter 300. The parameters 308 may include values related to the timers or thresholds, such as those described in FIG. 1 and FIG. 2. For example, the parameters may include values for outage recognition time, the cold load pick-up delay trigger, the service limiter demand period, and the service limiter threshold.

The optional communications module 312 may receive information, instructions, and messages from the central system to adjust the parameters 308 when the electric meter 300 is in normal operating mode. For example, a central system may transmit information to the optional communications module 312 to adjust the parameters 308 when the meter is in normal operating mode. The optional communications module 312 may also transmit parameter 308 information, e.g. measurements and parameters 308 of the electric meter 300, to the central system, which the central system may store in a database or other data management system. In other examples, a field service technician may adjust the parameters 308 of the electric meter 300 on-site. In further examples, the service limiter mode parameters 308 of the electric meter 300 may vary based on where the electric meter 300 is located in the electrical distribution network.

The electric meter may also include additional components. For example, memory may be a separate component, or may be included in one or more of the metrology 304, processing unit 306, controller 310, or the communications module 312. A processor or processing unit 306 may be included in any of the components. The processors may execute computer-readable instructions to configure the processors to perform the functions of the electric meter, including the metrology functions, processing functions, and communications functions described herein. The instructions may be stored in a computer-readable medium.

### Exemplary Implementation in an Electrical Distribution Network

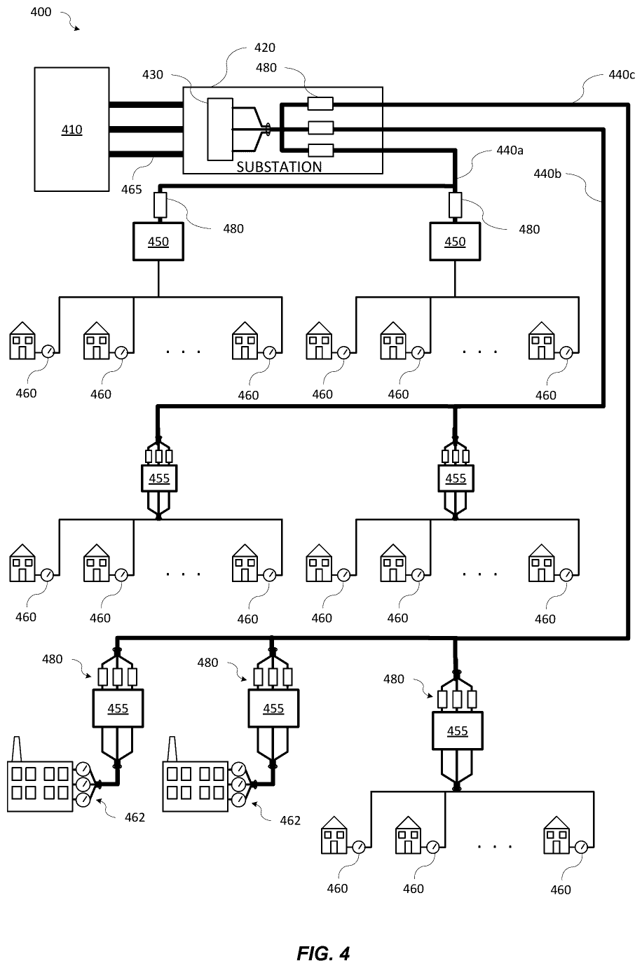

FIG. 4 represents an exemplary electrical distribution network. The electrical distribution network includes power generator 410, which may be a power generation facility or a power generator at a power generation facility. The power generator 410 may generate 3-phase alternating current (AC) power and transmit electrical power via transmission lines 465 to substation 420.

The substation 420 includes transformer 430 to step down the voltage for consumption of customers. The stepped down power is transmitted by transmission lines 440a, 440b, and 440c to transformers 450 and 455 which further step down the voltage for customer consumption.

Transformers 450 and 455 may deliver single or multi-phase power to customer premises through meters 460 and 462. The electric meters may monitor characteristics such as current, voltage, and power, and may be multi-phase meters. Further, other power assets other than those depicted may also be included in the electrical distribution network.

The electric meters 460 and 462 may operate differently in service limiter mode based on their location on the electrical distribution network. For example, one or more values for the cold load pick-up delay trigger, cold load pick-up delay timer, service limiter demand timer, and the service limiter threshold may vary based on the location of the electric meter 460, 462 within the distribution network or the premises associated with the electric meter 460 462.

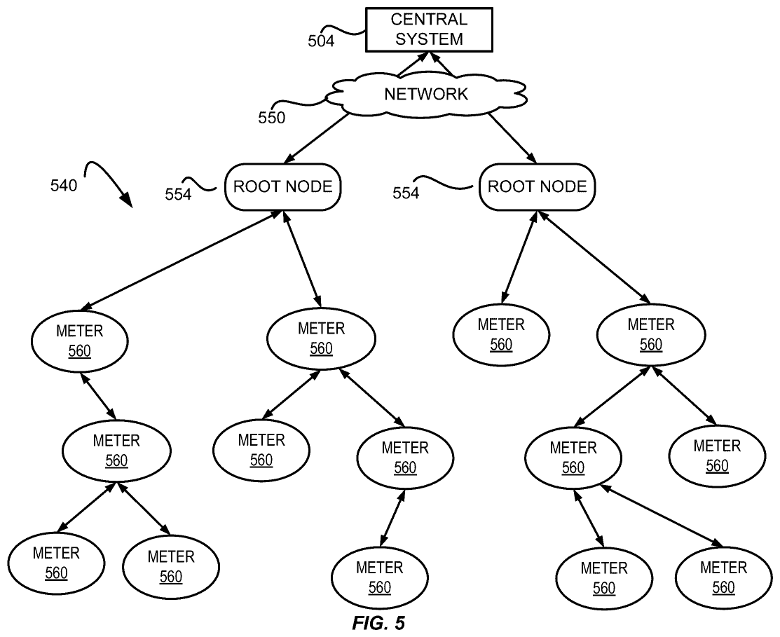

In some implementations, the electric meter 460 462 may be configured to have a cold load pick-up delay timer or open switch timer that is a shorter amount of time as compared to electric meters 460 462 at other locations. By shortening the cold load pick-up delay timer, the electric meter 460 462 may remain in service limiter mode for a shorter period of time, allowing for the electric meter 460 462 to return to normal operating mode to resume normal operations sooner than other electric meters 460 462. In some implementations, this may allow for the prioritization of some premises over others. For example, a hospital or other critical infrastructure may have an electric meter 460 462 that has a shorter cold load pick-up delay timer that would allow the hospital to return to normal metering operations faster than a residence. In other examples, the cold load pick-up delay timer may vary based on the location of the electric meter 460 462 on the electrical distribution network or in relation to other power assets within the electrical distribution network. For example, electric meters 460 462 may have different cold load pick-up delay timer values because of the electric meter's 460 462 distance from the power generator 410. Exemplary Communication Network The central system 504 may communicate with the electric meters 560 through a communications network as shown in FIG. 5. FIG. 5 is a wireless mesh network 540 that allows electric meters 560 to communicate with other meters 560 and a central system 504. The electric meters 560 may transmit information to other meters 560 to reach their respective root nodes 554. The electric meters 560 may communicate to each other through various wireless and wired communication technologies including: RF, WiSUN, satellite, 3g, 4g, UHB, WiFi, and other communication technologies.

The root nodes may be personal area network coordinators, gateways, border routers, or other devices capable of communicating with the central system 504 and other devices on the mesh network. Further, the root nodes 564 may forward information 522 to the central system 504 through network 550.

The information transmitted through the communications network may include parameters of the electric meter 560, such as threshold values and timer information. In some implementations, the central system 504 may transmit information to the electric meters 560 to update parameters of the electric meters 560. In other examples, the central system 504 may also query information from meters 560.

### Further Examples

In some examples of the electric meter, the parameters of the meter, such as the timer and threshold values may vary between meters based on a priority system set by the utility provider. For example, the service limiter threshold at a first premises may be set at a higher value than the service limiter threshold at a second premises based on a customer at the first premises paying for an enhanced level of service.

In other examples, the electric meter may transmit information to a central system upon entering normal operations mode from service limiter mode. While in normal operations mode, the electric meter may transmit information to the central system such as information collected during the time the electric meter operated in service limiter mode. The information may include whether the service limiter threshold was exceeded, the amount of power accumulated during service limiter mode, or the number of times the service limiter threshold was exceeded during a single service limited demand period. The information may be received by the central system and logged in a database.

In further examples, the electric meter may be configured to communicate to individual loads. In order to reduce demand of a premises so that demand is within the service limiter threshold, the electric meter may communicate to individual loads at the premises to power off or operate in a low-power mode in addition to controlling the service switch of the electric meter.

While the present subject matter has been described in detail with respect to specific aspects thereof, it will be appreciated that those skilled in the art, upon attaining an understand of the foregoing, may readily produce alternations to, variations of, and equivalents to such aspects. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method for operating an electric meter, comprising:
detecting a restoration of power following an outage;
in response to detecting the restoration of power following the outage, restarting operation and entering a service limiter mode for a predetermined amount of time;
while in the service limiter mode:
monitoring power from an electrical distribution network to a premises through the electric meter;
accumulating the power during a service limiter demand period;
comparing the accumulated power for the service limiter demand period to a service limiter threshold;
when the accumulated power for the service limiter demand period is within the service limiter threshold, controlling a service switch of the electric meter so the premises remain connected to the electrical distribution network;
determining an amount of time that has elapsed since entering the service limiter mode; and
when the amount of time elapsed since entering the service limiter mode meets or exceeds the predetermined amount of time, exiting the service limiter mode; and
entering a normal operating mode.

2. The method of claim 1, comprising:
while in the service limiter mode, when the accumulated power for the service limiter demand period exceeds the service limiter threshold, controlling the service switch to disconnect the premises from the electrical distribution network.

3. The method of claim 1, further comprising:
detecting the outage;
in response to detecting the outage, controlling the service switch to disconnect the premises from the electrical distribution network; and
in response to detecting the restoration of power following the outage, maintaining the service switch in a disconnected state until a second predetermined period of time expires or a restart command is received.

4. The method of claim 2, comprising:
receiving a restart command via a wireless network; and
controlling the service switch to connect the premises to the electrical distribution network.

5. The method of claim 1, wherein the predetermined amount of time of the service limiter mode is based on one or more of: location of the electric meter within the electrical distribution network, demand of a load associated with the electric meter, and input from a utility provider.

6. The method of claim 1, comprising:
in response to entering the service limiter mode, controlling a premises to prevent the premises from receiving power from the electrical distribution network while the electric meter operates in the service limiter mode.

7. The method of claim 1, comprising:
in response to entering normal operations mode, causing a message to be transmitted to a remote system.

8. A system for restoring power to one or more loads comprising:
an electric meter, wherein the electric meter is configured to:
detect a restoration of power following an outage, and in response to detecting the restoration of power following the outage, restart operation and enter a service limiter mode for a predetermined amount of time, wherein the predetermined amount of time is based on connection of the electric meter and one or more power assets of an electrical distribution network;
while in the service limiter mode:
monitor power from an electrical distribution network to a premises through the electric meter;
accumulate the power during a service limiter demand period;
compare the accumulated power for the service limiter demand period to a service limiter threshold;
when the accumulated power or the service limiter demand period is within the service limiter threshold, control a service switch of the electric meter so the premises remain connected to the electrical distribution network;
determine an amount of time that has elapsed since entering the service limiter mode; and
when the amount of time elapsed since entering the service limiter mode meets or exceeds the predetermined amount of time, exit the service limiter mode; and
enter a normal operating mode.

9. The system of claim 8, wherein while in the service limiter mode, when the accumulated power for the service limiter demand period exceeds the service limiter threshold, the electric meter controls the service switch to disconnect the premises from the electrical distribution network.

10. The system of claim 8, wherein the electric meter detects the outage, and in response to detecting the outage, controls the service switch to disconnect the premises from the electrical distribution network; and
in response to detecting the restoration of power following the outage, maintains the service switch in a disconnected state until a second predetermined period of time expires or a restart command is received.

11. The system of claim 10, wherein the electric meter receives the restart command via a wireless network; and
controls the service switch to connect the premises to the electrical distribution network.

12. The system of claim 10, wherein the electric meter determines that the second predetermined period of time has expired; and
controls the service switch to connect the premises to the electrical distribution network.

13. The system of claim 8, wherein in response to entering the service limiter mode, the electric meter controls a premises to prevent the premises from receiving power from the electrical distribution network while the electric meter operates in the service limiter mode.

14. The system of claim 8, wherein in response to entering normal operating mode, the electric meter causes a message to be transmitted to a remote system.

15. A method for operating an electric meter comprising:
entering a service limiter mode, wherein the electric meter limits power to a premises;
while in the service limiter mode:
determining demand associated with the premises;
comparing the demand to a threshold value;
when the demand for the premises exceeds the threshold value, setting a service switch to an open state;
when the demand is within the threshold value, setting the service switch to a closed state and determining an amount of time that has elapsed since entering the service limiter mode; and
when the amount of time elapsed since entering the service limiter mode meets or exceeds a predetermined amount of time, exiting the service limiter mode; and
entering a normal operating mode.

16. The method of claim 15, wherein the threshold value varies based on location of the electric meter within a distribution network.

17. The method of claim 15, wherein the predetermined amount of time is based on a location of the electric meter within a distribution network.

18. The method of claim 15, wherein the predetermined amount of time or the threshold value is preset at the electric meter by a utility provider.

19. The method of claim 15, further comprising:
transmit a message to a remote system when the electric meter enters a normal operating mode.

20. The method of claim 19, wherein the electric meter enters service limiter mode upon detects restoration of power from an outage event which persisted longer than a predetermined period of time.
